(19) United States
(12) Patent Application Publication
(10) Pub. No.: US 2010/0051419 A1
(43) Pub. Date: Mar. 4, 2010

(54) SYSTEM, METHOD AND APPARATUS FOR LOWERING THE VARIABILITY OF TEMPERATURE, MOISTURE CONTENT, AND ACRYLAMIDE LEVEL IN A FOOD PRODUCT

(76) Inventors: Pravin Maganlal Desai, Carrollton, TX (US); James Keith Henson, Richardson, TX (US); Christopher James Koh, Southlake, TX (US)

Correspondence Address: CARSTENS & CAHOON, LLP, P O BOX 802334, DALLAS, TX, 75380, US

(21) Appl. No.: 12/199,005

(22) Filed: Aug. 27, 2008

(51) Int. Cl. B65G 47/248; B65G 47/00

(52) U.S. Cl. 198/617; 198/411

(57) ABSTRACT

Disclosed is an improved system, method and apparatus for turning a bedded product to enhance the temperature uniformity of the product. In one aspect, the system is directed towards using a flow wheel to turn over a bed of hot product exiting a dehydrator. The improved system, method, and apparatus lowers the variability of temperature, moisture content, oil content and acrylamide levels in a bedded food product.

### BACKGROUND OF THE INVENTION

1. Technical Field

The present invention relates to an improved method for producing a fried food product having a reduced level of acrylamide variability. More specifically, the present invention relates to a method and apparatus to enhance product quality by lowering the variability of the temperature, moisture content, and acrylamide levels in a bedded food product exiting a dehydrator such as a deep fryer.

2. Description of Related Art

The chemical acrylamide has long been used in its polymer form in industrial applications for water treatment, enhanced oil recovery, papermaking, flocculants, thickeners, ore processing and permanent-press fabrics. Acrylamide precipitates as a white crystalline solid, is odorless, and is highly soluble in water (2155 g/L at 30° C.). Synonyms for acrylamide include 2-propenamide, ethylene carboxamide, acrylic acid amide, vinyl amide, and propenoic acid amide. Acrylamide has a molecular mass of 71.08, a melting point of 84.5° C., and a boiling point of 125° C. at 25 mmHg.

In recent times, a wide variety of foods have tested positive for the presence of acrylamide monomer. Acrylamide has especially been found primarily in carbohydrate food products that have been heated or processed at high temperatures. Examples of foods that have tested positive for acrylamide include coffee, cereals, cookies, potato chips, crackers, french-fried potatoes, breads and rolls, and fried breaded meats. In general, relatively low contents of acrylamide have been found in heated protein-rich foods, while relatively high contents of acrylamide have been found in carbohydrate-rich foods, compared to non-detectable levels in unheated and boiled foods.

It would be desirable to develop one or more methods of reducing the level of acrylamide in the end product of heated or thermally processed foods. Ideally, such a process should substantially reduce or eliminate the acrylamide in the end product without adversely affecting the quality and characteristics of the end product.

### SUMMARY OF THE INVENTION

The proposed invention provides a system, apparatus and method for making a fried food product having a reduced level of acrylamide, temperature, and moisture content variability. In one aspect, the invention is directed towards a turning apparatus comprising a plurality of rotatable blades wherein each rotatable blade has a flexible extension. In one aspect, the invention is directed towards a system for turning a bed of product comprising a flow wheel having a plurality of rotatable blades and a conveyor below the rotatable blades. In one aspect, the invention is directed towards a method for turning a bed of product on a conveyor by providing a trough, collecting the bed of product into the trough and rotating the trough. In one aspect, the invention is directed towards a method for turning a bed of fried products to minimize the temperature differential within the product by turning the bed of fried product over with a flow wheel.

Other aspects, embodiments and features of the invention will become apparent from the following detailed description of the invention when considered in conjunction with the accompanying drawings. The accompanying figures are schematic and are not intended to be drawn to scale. In the figures, each identical, or substantially similar component that is illustrated in various figures is represented by a single numeral or notation. For purposes of clarity, not every component is labeled in every figure. Nor is every component of each embodiment of the invention shown where illustration is not necessary to allow those of ordinary skill in the art to understand the invention. All patent applications and patents incorporated herein by reference are incorporated by reference in their entirety. In case of conflict, the present specification, including definitions, will control.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a side view of one embodiment of the present invention;

FIG. 2a-2c is a temporal side view of the flow wheel in accordance with one embodiment of the present invention;

FIG. 3 is a front perspective view of the flow wheel in accordance with one embodiment of the present invention;

FIG. 4 is a top view of the fryer, outlet conveyor, and flow wheel in accordance with one embodiment of the present invention;

FIG. 5 is a side view of the flow wheel in accordance with one embodiment of the present invention; and

FIG. 6 is a side view of the flow wheel in accordance with an alternative embodiment of the present invention.

### DETAILED DESCRIPTION

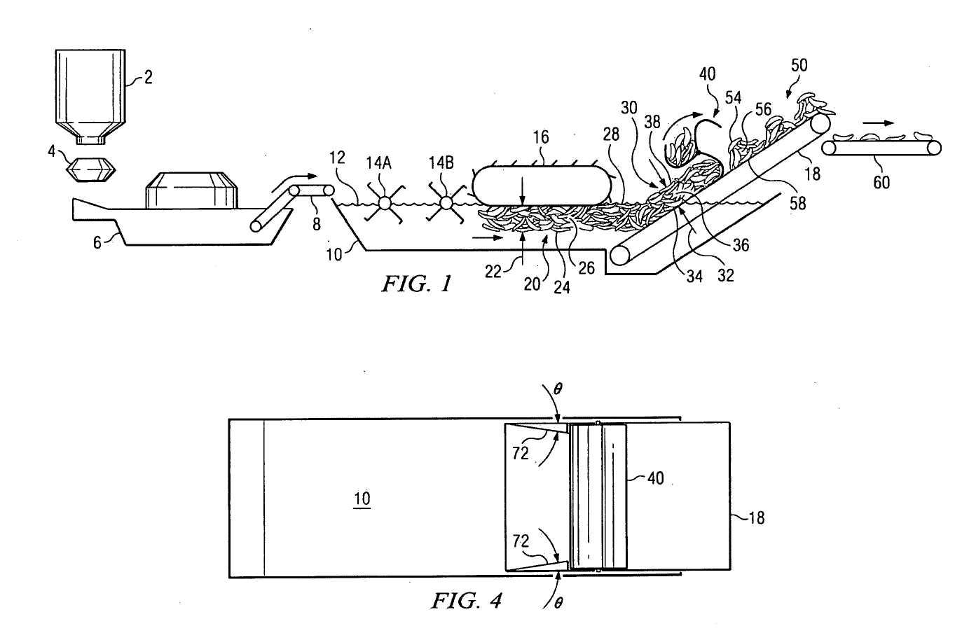

An embodiment of the innovative invention will now be described with reference to FIG. 1. Whole potatoes stored in hopper 2 are dispensed into a slicing apparatus 4 which drops potato slices into a water wash 6.

The slices are removed from the water wash 6 by an endless belt conveyor 8 and deposited in frying oil contained within a fryer 10. Because the present invention can be applicable to foods other than sliced potatoes, the invention will now be described generally as pertaining to food pieces.

The frying oil entering the fryer is maintained at an initial temperature between about 320° F. to about 380° F. more preferably between about 335° F. and about 370° F. Any conventional frying medium can be used in accordance with various embodiments of the present invention, including frying mediums with digestible and/or non-digestible oils. In one embodiment, the fryer is a continuous single flow or multizone fryer which utilizes devices such as paddle wheels, 14A and 14B, and a submergible conveyor belt 16 to control the flow of food pieces through the fryer 10. Once the potato slices or food pieces have been fried to a water content of less than about 3% by weight, the food pieces are removed from the fryer by a mesh endless belt conveyor 18. The conveyor 18 typically runs at a speed of between about 1-inch to 2-inches per second. The fried food pieces can be routed by a higher speed conveyor 60 to a tumbler for seasoning. The seasoned food pieces can then be packaged and shipped.

As shown by FIG. 1, the food pieces beneath the submerger 16 are typically in a bedded configuration 20 having a bed thickness 22. In one embodiment, the bed thickness 22 is roughly about 6 inches. It has been surprisingly discovered that the location of a food piece in the bed 20 when in the fryer 10 is a factor in the acrylamide level of the fried food piece. The food pieces maintain their general elevational position as they navigate through the fryer 10 beneath the submerger 16. Specifically, the food pieces at the bed bottom 24 typically stay at the bed bottom 24, food pieces in the middle 26 of the bed typically stay in the bed middle 26 and the food pieces at the top 28 of the bed typically stay at the bed top 28 as the fried food pieces move through the fryer beneath the submerger 16.

A temperature gradient forms in the fryer oil from the bed top 28 to the bed bottom 24; the bed bottom 24 being warmer since it is adjacent to hot oil 12 and the bed top 28 being cooler because the bed top 28 food pieces are surrounded by product being cooled down by evaporating water. Additional heat flux is also provided to the bed bottom 24 because freshly heated hot oil 12 typically enters the fryer 10 at or near the bottom of the fryer.

This temperature differential transfers to the bedded product 30 that has exited the fryer 10 and the fried food pieces on the bed bottom 34 of the exited bedded product 30 cool less than the fried food pieces on the bed top 38 for several reasons. First, because the bed bottom 34 fried food pieces are adjacent to the hot belt conveyor 18 having been heated by the hot oil, the heat from the conveyor 18 transfers to the bed bottom 34. Second, the bed bottom 34 is not exposed to the cooler gaseous fluid that the bed top 38 fried food pieces are exposed too. Finally, the product in the bed middle 36 and the bed bottom 34 are insulated by adjacent fried food pieces. While dependent upon the conveyor 18 speed, the bed thickness 32 is usually similar to the bed thickness 22 beneath the fryer and is typically about 6 inches. These fried food pieces typically stay on the outlet conveyor for 45 to about 60 seconds. Consequently, the fried food pieces on the bottom of the outlet conveyor 18 have lower moisture contents and higher acrylamide levels than the fried food pieces on the top of the bed with a top to bottom temperature gradient.

The bedded product 30 on the conveyor was tested at the bed bottom 34 the bed middle 36 and the bed top 38 for temperature and for levels of moisture content, and acrylamide. The averages of the samples are provided below:

TABLE 1
Positional average of temperature,
moisture content, and acrylamide levels.

| | Temperature | Moisture Content | Acrylamide |
|---|---|---|---|
| Location | (° F.) | (% by weight) | (ppb) |
| Top | 222 | 1.47 | 509 |
| Middle | 263 | 1.32 | 617 |
| Bottom | 289 | 1.16 | 712 |

The above table demonstrates that the acrylamide level in a fried food product can be dependent upon the position of the fried food piece in the food product bed. Consequently, if the food pieces near the bottom 34 of the bed can be turned over after the product exits the fryer so that the food pieces can cool, the variation of the acrylamide concentration in the fried food pieces can be reduced because most of the acrylamide formation occurs at higher temperatures and lower moisture contents and turning the bed over provides more uniform cooling.

Turning over the bed of food product on the outlet conveyor has proven difficult because the fried food pieces comprising the bedded configuration 20 30 are made up of interlocking food pieces. When flat dough pre-forms or flat potato pieces are fried in hot oil, the pieces can curl during deep frying. Because so many potato pieces are in close proximity and concurrently curling during frying, the inventors have discovered that the food product bed 20 becomes interlocked in all three dimensions when the food pieces are fried beneath the submergers 16. Consequently, when the bedded product 30 exits the fryer 10 on the outlet conveyor 18, the bed of food pieces need to scooped up to be turned over, otherwise they will get backed up on the conveyor 18. As an illustration of this difficulty, a beveled flat plate having a height comparable to the product bed, and a thickness 1/16-inches was placed in a stationary position longitudinally above the outlet conveyor 18 in an effort to divide the flow of bedded product 30 to guide a portion of the bedded product to a flow wheel having a length substantially less than the overall width of the conveyor. In another test, an attempt was made to push the plate into the bedded product by moving the plate toward the fryer. In both cases, the bedded product 30 did not divide, and because of the interlocking of the food pieces, the bedded product 30 was stopped by the beveled, flat plate and backed up on the conveyor 18. Interestingly, if the plate was vibrated to loosen the bed and reduce the interlocking forces between the food pieces, the bed could be divided.

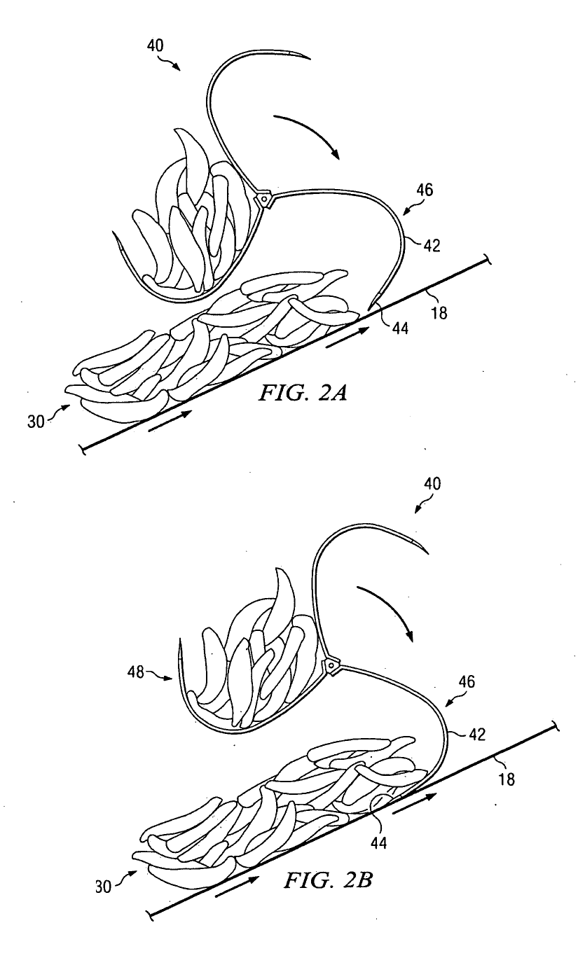

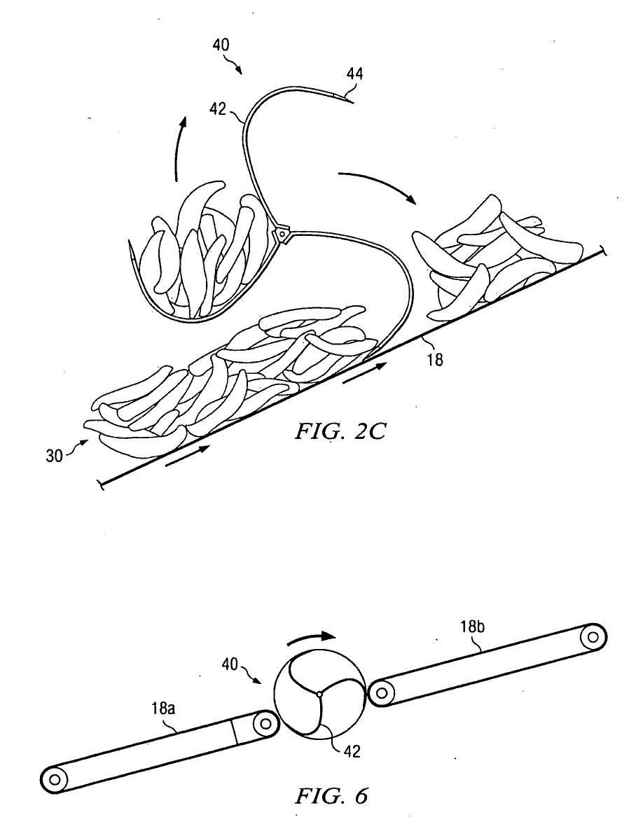

FIG. 2a-2c is a temporal side view of the flow wheel 40 in accordance with one embodiment of the present invention. Referring to FIG. 2a, in the embodiment shown, the flow wheel 40 comprises a plurality of rotatable blades 42. In one embodiment, the blades 42 are concave in shape and form a trough 46 for holding food product. As the bedded product 30 is carried by the conveyor 18, the flow wheel 40 rotates in the clockwise position. Because of the interlocking of bedded product 30, the blades 42 in one test failed to pick up and turn over the bedded product 30 on a continuous basis because of a gap between the distal end of the blade 42 and the conveyor 18. Rather, as the bedded product 30 engaged the distal end of the blade 42, the blade 42, as it was rotated slowly, initially was able to scoop in most of the bedded product 30. However, at each subsequent rotation, the amount of bedded product 30 being scooped into the blades 42 decreased and the blades 42 eventually stopped scooping bedded product 30 because the bedded product 30 was interlocked. As a result, the bedded product backed up on the conveyor 18.

To solve this problem, in one embodiment, each blade 42 has a flexible extension 44 mounted about the entire width of the blade 42 on the distal end of the blade 42. The flexible extension 44 is sized short enough in length to ensure that during its circular trajectory, the flexible extension 44 does not contact the conveyor 18 at an angle that could damage either the blade 42 or the conveyor 18 moving in the opposite direction. The flexible extension advantageously bends to become flat on the conveyor 18 and both the conveyor 18 and the blade 42 continue to move in the opposite direction without any gap between the conveyor 18 and the flexible extension 44. While the flexible extension 44 is flat on the conveyor 18 and traveling in the opposite direction of the conveyor 18, the bedded product 30 can be scooped into the trough 46. Because of the flexibility of the extension 44, the flow wheel 40 can be lowered towards the conveyor 18 so that there is no substantial gap between the distal end of the blade 42 and the bottom of the bedded product 30 to cause the bedded product 30 to back up. Without the flexible extension 44, the distal end of the blade 42 can damage the conveyor 18. In one embodiment, the flexible extension 44 comprises a length of between about ¼-inch and about 4-inches. Of course, such range is provided for purposes of illustration and not limitation. The flexible extension 44 can be made of DELRIN or other suitable material.

Referring to FIG. 2b, because the flexible extension 44 is substantially flat on the conveyor 18 and moving in the opposite direction of the conveyor 18, the bedded product 30, even if comprising interlocked product, can be collected into the trough 46. If the bedded product 30 comprises interlocking food pieces, then use of a rigid blade 42 without the flexible extension 44 fails to collect the food pieces into the trough 46 because of the gap created between the distal end of the blade 42 and the conveyor 18 during the circular movement of the blade 42. In one embodiment, the flexible extension 44 and/or the blades 42 are moving when being used to collect the bed of food product into the trough 46. Such movement can provide a scooping action to collect the food pieces forming the bedded product 30 into the trough 46.

Referring to FIG. 2c, as the flow wheel 40 rotates clockwise, the food product bed previously collected has been turned over and is discharged back onto the conveyor 18 as another load of product is collected. In one embodiment, the flow wheel 40 turns at a constant rotational speed. For example, the rotation of the flow wheel 40 can be timed to collect and turn product at the same rate as the product exits the conveyor 18. In one embodiment, the flow wheel turns at a variable rotational speed. For example, it may be desirable for the flow wheel to turn at a faster or slower speed as the distal end of the blade and/or flexible extension 44 first contacts the product bed 30 to facilitate a scooping action and/or break the interlocking of the product bed. In one embodiment, the rotational speed of the flow wheel 40 can be manipulated such that the rotational speed accelerates after it has collected or scooped the bedded product 30 into the trough so that the blade 42 is not in the way of the next batch being continuously fed by the conveyor 18. In one embodiment, the acceleration is followed by a deceleration during the scooping action. The rotational speed profile can also be configured to provide a vibratory/jerking motion to the flexible extension 44 or the distal end of the blade 42 to loosen the interlocked bedded product. For example, in one embodiment, the flow wheel 40 rotates back and forth slightly at a high frequency when the distal edge of the blade 42 or flexible extension 44 is about to contact the bedded product 30 to facilitate breaking up the interlocked bedded product 30.

Referring back to FIG. 1 and FIG. 2c, the turned over product bed 50 has a substantially sinusoidal shape. In one embodiment, the rotating flow wheel 40 turns the bedded product 30 over such that the top 38 fried food pieces are now on the bottom 58 of the product bed 50 exiting the flow wheel 40. Similarly, the bottom 34 fried food pieces in the bedded product 30 entering the flow wheel 40 are disposed on the top 54 of the product bed 50 exiting the flow wheel 40. Such turning over of the food product helps alleviate the temperature differential of product bed 50. Thus, the bed bottom 24 food pieces having the warmest temperature in the fryer can be turned over and cooled much quicker due to the cooler gaseous fluid at the top 54 of the product bed 50. Because acrylamide formation is not favored at lower temperatures, even at low moisture contents, the additional acrylamide formation that previously occurred because of the time (e.g., 45 seconds to 1 minute) the bottom of the bedded food product spent on the outlet conveyor does not occur in accordance with the present invention.

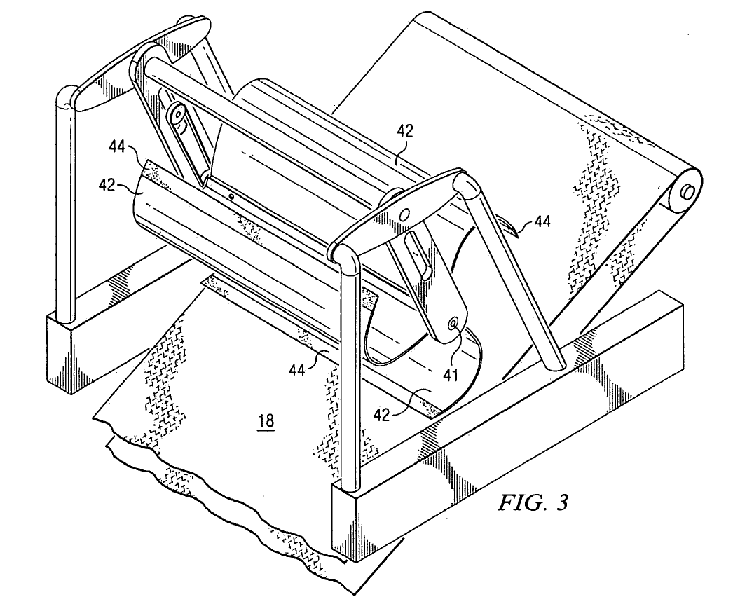

FIG. 3 is a front perspective view of the flow wheel in accordance with one embodiment of the present invention. As shown in FIG. 3, the flow wheel 40 having a plurality of rotatable blades 42 can be mounted above the outlet conveyor 18 and can span substantially the entire width of the outlet conveyor. The blades 42 are sufficiently rigid so as to maintain their general shape while in operation. It should be pointed out that while the blades 42 are shown to be substantially parabolic and concave, such configuration is provided for purposes of illustration and not limitation. The blades on the flow wheel can be straight, arcuate, concave, shaped to hold product, shaped to form a trough, etc. The flexible extension 44 can be mounted about the entire width of the distal end of each blade 42. In one embodiment, the flow wheel 40 comprises a diameter of about 18 inches.

FIG. 4 is a simplified top view of the fryer 10, outlet conveyor 18 and flow wheel 40 in accordance with one embodiment of the present invention. As shown by FIG. 4, guides 72 are used to direct the bed of food product towards the flow wheel 40. Such guides 72 can be advantageous to move the bedded product 30 into the flow wheel 40 without causing the bedded product to back up on the conveyor 18. The angle Θ should be minimized to ensure the bedded product 30 does not back up. Those having ordinary skill in the art, armed with this disclosure, will be able to determine the optimal angle Θ.

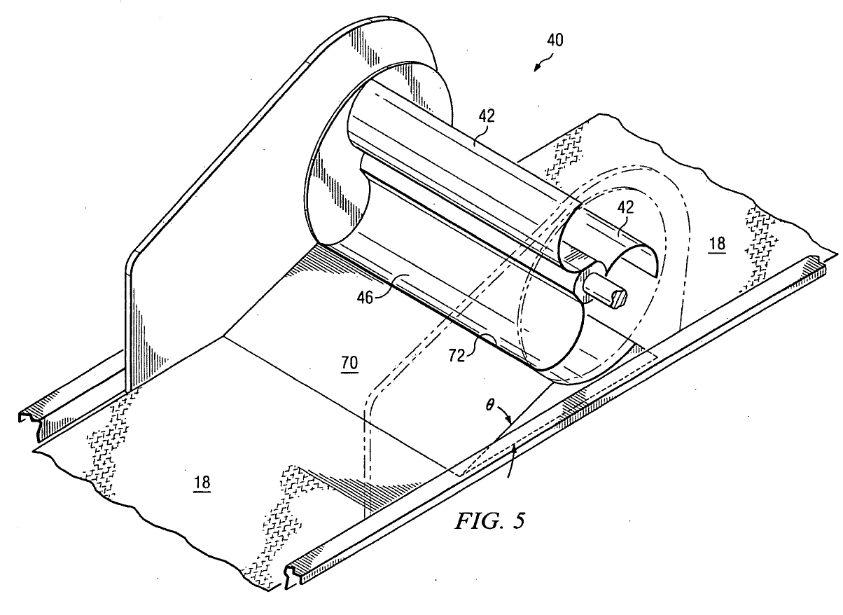

FIG. 5 is a side view of the outlet conveyor 18 and flow wheel 40 in accordance with an alternative embodiment of the present invention. In the embodiment shown, a ramp 70 about the entire width of the flow wheel is provided in place of a flexible extension 44 to guide the bed of food product into the trough 46. The top surface of the ramp 70 can be linear or curvilinear as desired. Because the ramp 70 raises the bedded product 30 and allows the distal edge of the blade 42 to be positioned just slightly below the ramp top 72, the bedded product 30 can easily fall into the flow wheel trough 46 without causing any product backup. Because the conveyor 18 is moving the bedded product 30 towards the flow wheel 40, the ramp 70 length and the ramp angle Φ should be minimized. Those having ordinary skill in the art, armed with this disclosure, will be able to ascertain the optimal ramp 70 dimensions. In the embodiment shown, the ramp 70 extends about the entire width of the conveyor. In an alternative embodiment, one or more guides 72 (shown in FIG. 4) are used to directed product toward the ramp 70.

In one embodiment (not shown), the conveyor 18 itself is the ramp 70. For example, a roller can be placed beneath the conveyor 18 and can extend about the width of the conveyor just prior to the flow wheel 40 to elevate a portion of the conveyor 18 about the width so that product can be collected into the trough 46. In such embodiment, the ramp 72 is integral with the conveyor. Such embodiment can reduce the gap between the distal end of the blade and the conveyor across the entire width of the flow wheel. The raised contour of the conveyor can also provide easier transition of product into the trough. Use of a ramp may preclude the need for a flexible extension discussed above.

Another potential problem with collecting bedded product 30 can occur if the conveyor sags about the width. For example, depending upon the width of the conveyor, the middle of the conveyor 18 can sag, preventing the flow wheel 40 from collecting bedded product 30 with a scooping action beneath the bedded product 30. Consequently, in one embodiment, one or more support structures (not shown) can be placed beneath the conveyor 18 in the vicinity of the flow wheel 40 so that the elevation of the conveyor is constant along the width. Support structures can be a plurality of v-shaped members beneath the conveyor with the apex pointed downstream or transverse support structures such as a free rotating idler. Any support structure that prevents the conveyor from sagging can be used.

FIG. 6 is a side view of the flow wheel in accordance with an alternative embodiment of the present invention. As shown in FIG. 6, the flow wheel 40 can be disposed between a first conveyor 18a and a second conveyor 18b. The flow wheel 40 can be positioned such that the distal end of the blade 42 is placed just slightly underneath the first conveyor 18a to permit the bedded product 30 to drop into the trough. The product can then be deposited back on the second conveyor 18b.

The present invention is able to reduce the temperature and moisture gradient in a bedded food product and can thereby reduce the variability of the acrylamide level of fried foods without sacrificing the organoleptical properties. Another advantage provided by the present invention is that the flow wheel permits oil to be drained from the food product as the food product is turned over. Such draining minimizes the potential for oil to accumulate at the bottom of the packed bed, and such accumulation can give rise to variability in oil content between the top and bottom of the bed. Consequently, the present invention advantageously also provides a way to minimize the oil variability in a packed bed.

It should be pointed out that while some embodiments of the present invention are directed towards a potato slice embodiment; other embodiments can be used in accordance with the spirit and scope of the present invention. Consequently, where potato slices are referred to herein, Applicants mean to include any food product that continuously exits a dehydration medium with a temperature differential in the exiting product stream. Thus, while food product exiting a dehydrator in a bed is clearly within the scope of the present invention, food products exiting in a monolayered fashion can also be turned in accordance with the scope and intent of the present invention. For example, cookies or crackers can exit in a monolayered fashion, but can be on a hot conveyor that can create a temperature differential in that food product from top to bottom. Further, the present invention can also be applied to dough-based embodiments and fabricated food products including, but not limited to, corn chips and tortilla chips. For example, a corn chip or a tortilla chip exiting a fryer in a bedded configuration can be turned over in the same way as potato chips. Similarly, addition to fryers, the present invention can be used where hot food exits any dehydrator in a bedded configuration including, but not limited to, an oven.

Further, while the distal end of the flow wheel blades have been shown as substantially linear about the width of the blades, it should be pointed out that other embodiments can be used. For example, in one embodiment the distal end of the flexible extension, if a flexible extension is used and/or the blade comprises a curvilinear geometry along the width of the conveyor. The curvilinear geometry can be designed to pierce through the interlocking bed of product. Consequently, in one embodiment, the distal end of the flexible extension and/or the distal end of the blades can comprise curvilinear geometry including but not limited to spike configurations, pointed configurations and variations thereof.

While this invention has been particularly shown and described with preferred embodiment, it will be understood by those skilled in the art that various changes and form detail may be made therein without departing from the spirit and scope of the invention.

What is claimed is:

1. A turning apparatus comprising:
a plurality of rotatable blades, each blade having a distal end, wherein each rotatable blade comprises a flexible extension attached to said distal end.

2. The apparatus of claim 1 wherein at least one of said rotatable blades is concave.

3. The apparatus of claim 1 further comprising one or more support structures beneath a conveyor upstream of said turning apparatus.

4. The apparatus of claim 1 wherein at least one of said rotatable blades are shaped to form a trough therein.

5. The apparatus of claim 1 wherein said turning apparatus comprises at least one guide aligned to funnel product on a conveyor to said turning apparatus.

6. The apparatus of claim 1 wherein said turning apparatus is disposed between a first conveyor and a second conveyor.

7. The apparatus of claim 1 wherein said turning apparatus is mounted above a conveyor and said conveyor comprises a ramp.

8. The apparatus of claim 7 wherein a ramp is integral with a conveyor.

9. The apparatus of claim 1 wherein said flexible extension is curvilinear.

10. The apparatus of claim 1 wherein a ramp is mounted upstream of said turning apparatus.

11. The apparatus of claim 1 wherein said turning apparatus rotates at a variable rotational speed profile.

12. The apparatus of claim 1 wherein said turning apparatus rotates at a constant speed.

13. A system for turning a food product having a temperature differential, said system comprising:
a flow wheel having a plurality of rotatable blades; and
a conveyor for routing said food product to said rotatable blades.

14. The system of claim 13 further comprising a ramp upstream of said rotatable blades.

15. The system of claim 14 wherein said ramp comprises a ramp mounted above and disposed along a conveyor width.

16. The system of claim 14 wherein said ramp is integral with said conveyor.

17. The system of claim 13 wherein at least one of said rotatable blades comprises a distal end that is curvilinear.

18. The system of claim 13 comprising one or more support structures beneath a conveyor upstream of said turning apparatus to prevent said conveyor from sagging.

19. The system of claim 13 further comprising at least one guide aligned to funnel product into said flow wheel.

20. The system of claim 13 wherein at least one of said rotatable blades further comprises a flexible extension.

21. The system of claim 13 wherein said flow wheel is positioned such that the distal end of at least one of said rotatable blades is beneath said conveyor.

22. A method for turning a food product on a conveyor, said method comprising the steps of:
a) providing a first rotatable blade and a second rotatable blade having a first trough therebetween;
b) collecting said bed of product into said trough from a conveyor; and
c) rotating said first trough.

23. The method of claim 22 wherein said rotating at step c) comprises a variable rotational speed.

24. The method of claim 22 wherein said rotating at step c) comprises a constant rotational speed.

25. A method for turning a bed of product to minimize a moisture, oil and temperature differential within said product, said method comprising steps of:
a) frying a food product in hot oil thereby providing a bed of fried food;
b) removing said bed of fried food pieces from said hot oil by a conveyor;
c) turning said bed of fried food over with a flow wheel disposed above said conveyor.

26. The method of claim 25 wherein said turning at step c) comprises a variable rotational speed.

27. The method of claim 25 wherein said turning at step c) comprises a constant rotational speed.
